(19) United States
(12) Patent Application Publication
(10) Pub. No.: US 2013/0343552 A1
(43) Pub. Date: Dec. 26, 2013

(54) CIRCUIT FOR TESTING BUZZER

(71) Applicants: Hon Hai Precision Industry Co., Ltd., New Taipei (TW); Hong Fu Jin Precision Industry (ShenZhen) Co., Ltd., Shenzhen (CN)

(72) Inventors: GUI-FU XIAO, Shenzhen (CN); XIAO-GANG YIN, Shenzhen (CN); WAN-HONG ZHANG, Shenzhen (CN)

(21) Appl. No.: 13/910,214

(22) Filed: Jun. 5, 2013

(30) Foreign Application Priority Data
Jun. 21, 2012 (CN) 2012102067350

(51) Int. Cl. H04R 29/00

(52) U.S. Cl. CPC H04R 29/008
USPC 381/58

(57) ABSTRACT

A circuit for testing a buzzer includes a microphone, an amplifier circuit, a microprocessor circuit, and a display circuit. The amplifier circuit is configured to amplify an analog signal from the microphone to an amplified signal. The microprocessor circuit determines whether a loudness and a frequency of the amplified signal are within proper ranges. The buzzer is qualified if the loudness and frequency of the amplified signal are within the proper ranges. The display unit displays the loudness, the frequency, and a test result.

### BACKGROUND

1. Technical Field

The present disclosure relates to a circuit for testing a buzzer.

2. Description of Related Art

A buzzer, or a speaker arranged on a motherboard, is employed to sound when components of the motherboard malfunction. Accordingly, it is critical to test whether the buzzer is operating or not. However, the test is usually completed by hearing the sound from the buzzer, which may be inaccurate.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a circuit for testing a buzzer of the present disclosure, wherein the circuit includes a microphone, an amplifier circuit, a gain circuit, a microprocessor circuit, a display circuit, and an interface circuit.

FIG. 2 is a circuit diagram of the amplifier circuit and microphone of FIG. 1.

FIG. 3 is a circuit diagram of the gain circuit of FIG. 1.

FIG. 4 is a circuit diagram of the microprocessor circuit of FIG. 1.

FIG. 5 is a circuit diagram of the display circuit of FIG. 1.

FIG. 6 is a circuit diagram of the interface circuit of FIG. 1.

### DETAILED DESCRIPTION

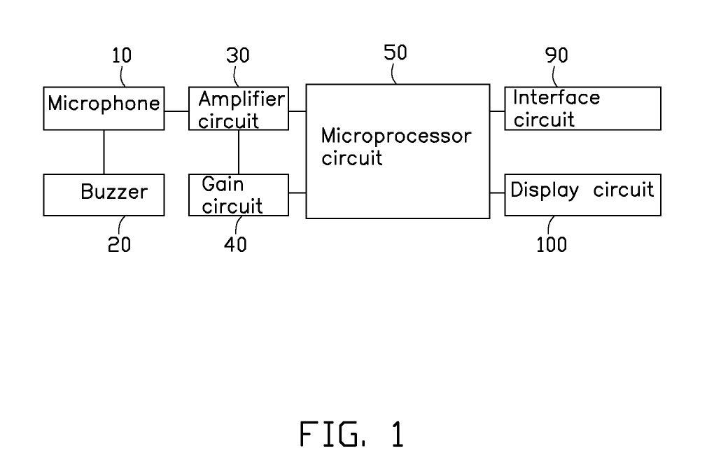

FIG. 1 illustrates an embodiment of a circuit for testing a buzzer 20 of the present disclosure. The circuit includes a microphone 10, an amplifier circuit 30, a gain circuit 40, a microprocessor circuit 50, an interface circuit 90, and a display circuit 100.

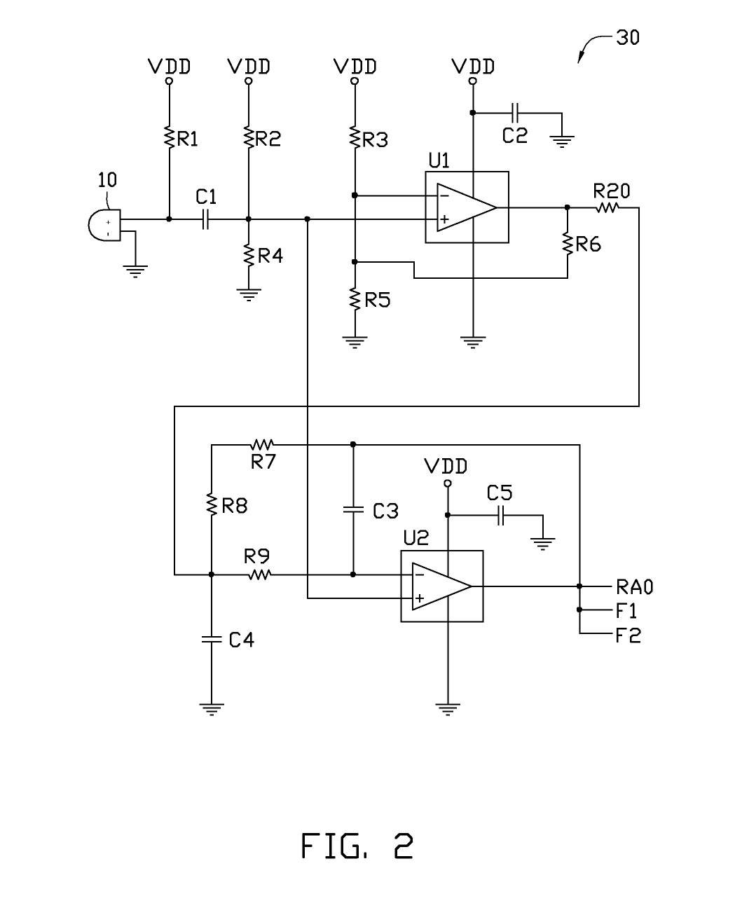

FIG. 2 shows that a cathode of the microphone 10 is connected to ground. An anode of the microphone 10 is configured to output an analog signal corresponding to a sound having a certain loudness generated by the buzzer 20 upon a condition that the buzzer 20 receives an audio signal from the microprocessor circuit 50.

The amplifier circuit 30 is configured to amplify the analog signal from the microphone 10, to output an amplified signal. The amplifier circuit 30 includes two amplifiers U1 and U2, ten resistors R1-R9 and R20, and five capacitors C1-C5. An inverting terminal of the amplifier U1 is coupled to a power terminal VDD through the resistor R3, and is connected to ground through the resistor R5. A power terminal of the amplifier U1 is coupled to the power terminal VDD, and is connected to ground through the capacitor C2. A non-inverting terminal of the amplifier U1 is coupled to the anode of the microphone 20 through the capacitor C1, connected to the power terminal VDD through the resistor R2, and connected to ground through the resistor R4. The anode of the microphone 10 is coupled to the power terminal VDD through the resistor R1. An output terminal of the amplifier U1 is coupled to an inverting terminal of the amplifier U2 through the resistor R20, and is also coupled to the inverting terminal of the amplifier U1 through the resistor R6. The inverting terminal of the amplifier U2 is connected to ground through the resistor R9 and capacitor C4 in that order, and is connected to ground through the capacitor C3, the resistors R7 and R8, and the capacitor C4 in that order. A non-inverting terminal of the amplifier U2 is coupled to the non-inverting terminal of the amplifier U1. A power terminal of the amplifier U2 is connected to ground through the capacitor C5, and is connected to the power terminal VDD. A ground terminal of the amplifier U2 is grounded. An output terminal of the amplifier U2 is configured to output the amplified signal.

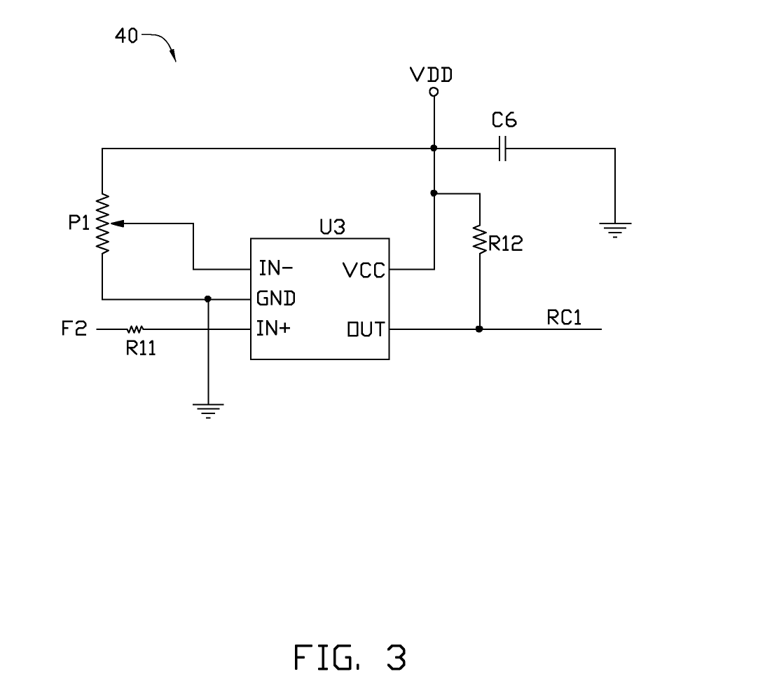

FIG. 3 shows that the gain circuit 40 is configured to re-amplify the amplified signal output from the amplifier circuit 30. The gain circuit 40 includes a rheostat P1, a comparator U3, two resistors R11 and R12, and a capacitor C6. A voltage reference pin IN− of the comparator U3 is coupled to a wiper end of the rheostat P1. A ground pin GND of the comparator U3 is connected to ground. A first end of the rheostat P1 is coupled to the power terminal VDD. A second end of the rheostat P1 is connected to ground. A power pin VCC of the comparator U3 is coupled to the power terminal VDD, and is also connected to ground through the capacitor C6. An input pin IN+ of the comparator U3 is coupled to the output terminal of the amplifier U2 through the resistor R11. An output pin OUT of the comparator U3 is configured to output a re-amplified signal. In the embodiment, the gain circuit 40 is configured to re-amplify the amplified signal with a low frequency from the amplifier circuit 30, to improve accuracy of sampling for the microprocessor circuit 50. In other embodiments, the microprocessor circuit 50 may directly sample the amplified signal from the amplifier circuit 50 when the amplified signal has a high frequency.

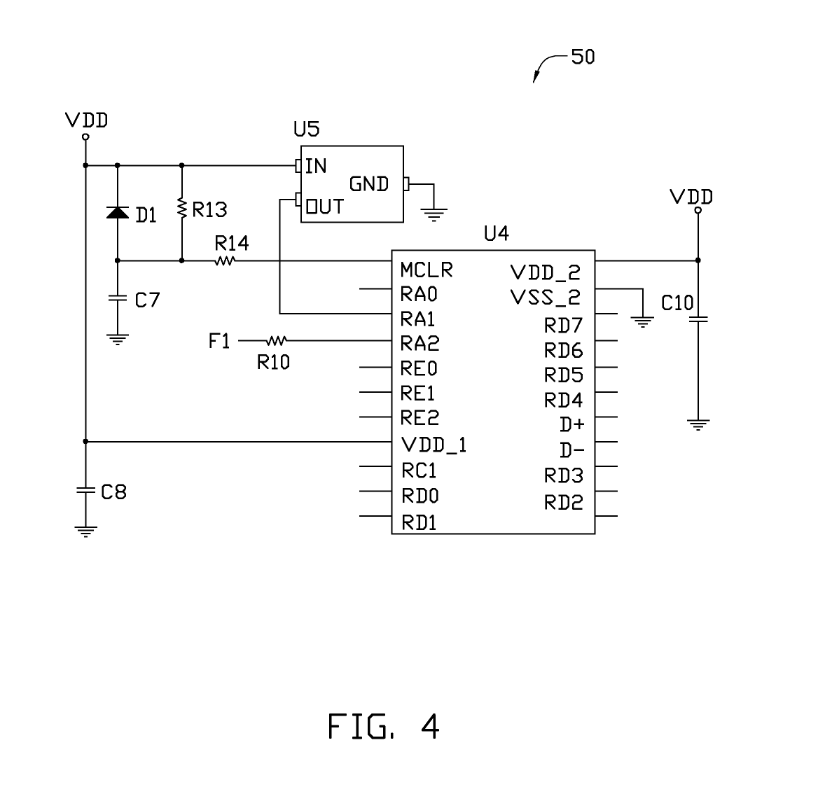

FIG. 4 shows that the microprocessor circuit 50 includes a microprocessor U4, a voltage regulator chip U5, a diode D1, three resistors R10, R13, and R14, and three capacitors C7, C8, and C10. A first power pin MCLR of the microprocessor U4 is coupled to the power terminal VDD through the resistors R14 and R13 in that order, and is connected to ground through the resistor R14 and the capacitor C7 in that order. A cathode of the diode D1 is coupled to the power terminal VDD, and an anode of the diode D1 is coupled to a node between the resistors R13 and R14. A voltage reference pin RA1 of the microprocessor U4 is coupled to an output pin OUT of the voltage regulator chip U5. An input pin IN of the voltage regulator chip U5 is coupled to the power terminal VDD. A ground pin GND of the voltage regulator chip U5 is connected to ground. A second power pin VDD_1 of the microprocessor U4 is coupled to the power terminal VDD, and is connected to ground through the capacitor C8. The voltage regulator chip U5 outputs a reference voltage to the voltage reference pin RA1 of the microprocessor U4, to enable the microprocessor U4 to perform analog to digital (A/D) conversion operation. A third power pin VDD_2 of the microprocessor U4 is coupled to the power terminal VDD, and is connected to ground through the capacitor C10. A ground pin VSS_2 of the microprocessor U4 is connected to ground.

An A/D conversion pin RA0 of the microprocessor U4 is coupled to the output terminal of the amplifier U2, to obtain a loudness corresponding to the amplified signal. A first frequency pin RA2 of the microprocessor U4 is coupled to the output terminal of the amplifier U2 through the resistor R10, to receive the amplified signal from the amplifier unit 30, and obtain a frequency corresponding to the amplified signal. A second frequency pin RC1 of the microprocessor U4 is coupled to the output pin OUT of the comparator U3, to receive the re-amplified signal, and obtains a frequency corresponding to the re-amplified signal. In one embodiment, the microprocessor U4 determines whether the amplified signal is a high frequency. The microprocessor U4 will sample the amplified signal if the amplified signal has a high frequency, and will sample the re-amplified signal if the amplified signal has a low frequency.

The microprocessor U4 pre-stores the loudness and the frequency of a file, and outputs the audio signal corresponding to the file to be played by the buzzer 20. The microprocessor U4 determines whether the loudness and the frequency of the amplifier signal or the re-amplifier signal is within a proper range. For example, the microprocessor U4 determines the loudness of the amplifier signal or the re-amplifier signal is within a first predetermined range, and determines the frequency of the amplifier signal or the re-amplifier signal is within a second predetermined range. The buzzer 20 is qualified when the loudness of the amplified signal or re-amplified signal is within the first predetermined range and the frequency of the amplified signal or re-amplified signal is within the second predetermined range. Otherwise, if at least one of the loudness of the amplified signal or re-amplified signal is not within the first predetermined range and at least one of the frequency of the amplified signal or re-amplified signal is not within the second predetermined range, the buzzer 30 is unqualified.

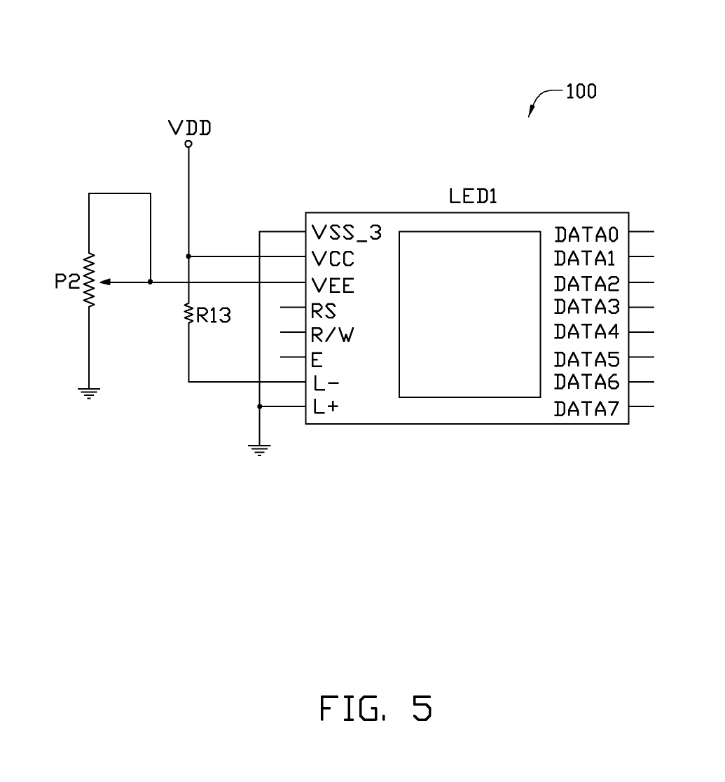

FIG. 5 shows that the display circuit 100 is configured to display the test result of whether the buzzer 20 is qualified or unqualified, and the loudness and the frequency. The display circuit 100 includes a display chip LED1, a rheostat P2, and a resistor R13. A pin VEE of the display chip LED1 is coupled to a wiper end of the rheostat P2. A first end of the rheostat P2 is coupled to the pin VEE, and a second end of the rheostat P2 is grounded. A power pin VCC of the display chip LED1 is coupled to the power terminal VDD. A pin L− of the display chip LED1 is coupled to the power terminal VDD through the resistor R13. A pin L+ of the display chip LED1 is grounded. Eight data pins DATA0-DATA7 of the display chip LED1 are respectively coupled to eight data pins RD0-RD7 of the microprocessor U4. Three control pins RS, R/W, and E of the display chip LED1 are respectively coupled to three control pins RE0, RE1, and RE2.

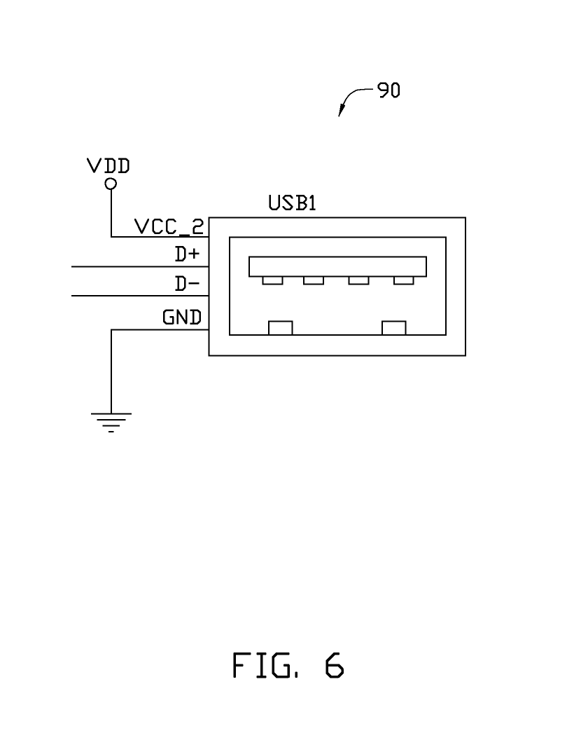

FIG. 6 shows that the interface circuit 90 includes a universal serial bus (USB) interface chip USB1. A power terminal VCC_2 of the USB interface chip USB1 is coupled to the power terminal VDD. A ground pin GND of the USB interface chip USB1 is connected to ground. Two data pins D+ and D− of the USB interface chip USB1 are respectively coupled to two data pins D+ and D− of the microprocessor U4. The interface circuit 90 is employed to transmit the test result, the loudness, and/or the frequency to a computer.

While the disclosure has been described by way of example and in terms of preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A circuit for testing a buzzer, comprising:
a microphone configured to generate an analog signal corresponding to a sound from the buzzer, by playing an audio signal corresponding to a file;
an amplifier circuit configured to amplify the analog signal from the microphone, and output an amplified signal;
a microprocessor circuit performing an analog to digital (A/D) conversion operation on the amplified signal, to obtain a first loudness of the amplified signal, and sampling the amplified signal to obtain a first frequency of the amplified signal; the microprocessor unit circuit determining whether the first loudness is within a first predetermined range, and determining whether the first frequency is within a second predetermined range; and
a display unit configured to display the first loudness, the first frequency, and a test result of the buzzer.

2. The circuit of claim 1, wherein the microprocessor circuit further determines whether the amplified signal has a high frequency.

3. The circuit of claim 2, further comprising a gain circuit, wherein the gain circuit is coupled to the amplifier circuit, to receive the amplified signal, and output a re-amplified signal in response that the amplified signal has a low frequency determined by the microprocessor circuit, the microprocessor circuit further determines whether a second loudness corresponding to the re-amplified signal is within the first predetermined range, and determines whether a second frequency corresponding to the re-amplified signal is within the second predetermined range; the buzzer passes the test if the second loudness is within the first predetermined range and the second frequency is within the second predetermined range.

4. The circuit of claim 3, further comprising an interface circuit, wherein the microprocessor circuit transmits the frequency, the loudness, and the test result through the interface circuit.

5. The circuit of claim 4, wherein the amplifier circuit comprises a first amplifier, a second amplifier, a first capacitor, a second capacitor, and first to third resistors; wherein power terminals of the first and second amplifiers are coupled to a power terminal, ground terminals of the first and second amplifiers are connected to ground; a non-inverting terminal of the first amplifier is coupled to the microphone through the first capacitor, an inverting terminal of the first amplifier is coupled to the power terminal, and is connected to ground through the first resistor, an output terminal of the first amplifier is coupled to the inverting terminal of the first amplifier through the second resistor; an inverting terminal of the second amplifier is coupled to the output terminal of the first amplifier, a non-inverting terminal of the second amplifier is coupled to the non-inverting terminal of the first amplifier, an output terminal of the second amplifier is coupled to the inverting terminal of the second amplifier through the third resistor, and is configured to output the amplified signal.

6. The circuit of claim 5, wherein the gain circuit comprises a comparator chip, a rheostat, and a fourth resistor, a power pin of the comparator chip is coupled to the power terminal, a ground pin of the comparator is connected to ground, an input pin of the comparator chip is coupled to the output terminal of the second amplifier; a voltage reference pin of the comparator chip is coupled to a wiper end of the rheostat, a first end of the rheostat is connected to ground, a second end of the rheostat is coupled to the power terminal, an output pin of the comparator chip is configured to output the re-amplified signal.

7. The circuit of claim 6, wherein the microprocessor circuit further comprises a microprocessor and a voltage regulator chip; an input pin of the voltage regulator is coupled to the power terminal, a ground pin of the voltage regulator chip is grounded, an output pin of the voltage regulator outputs a reference voltage to the microprocessor, the microprocessor performs the A/D conversion and sampling operations according to the reference voltage.

8. The circuit of claim 4, wherein the interface circuit comprises a universal serial bus (USB) interface, wherein a power pin of the USB interface is coupled to the power terminal, a ground pin of the USB interface is grounded, data pins of the USB interface are employed to transmit the loudness, the frequency, and the test result.
